(19) United States
(12) Patent Application Publication
(10) Pub. No.: US 2006/0169837 A1
(43) Pub. Date: Aug. 3, 2006

(54) Flexible actuator with integral control circuitry and sensors

(76) Inventors: Ross W. Bird, Canton, PA (US); Gareth J. Knowles, Williamsport, PA (US)

Correspondence Address: Michael G. Crilly, Esquire, 104 South York Road, Hatboro, PA, 19040, US

(21) Appl. No.: 11/344,776

(22) Filed: Feb. 1, 2006

Related U.S. Application Data
(60) Provisional application No. 60/649,202, filed on Feb. 2, 2005.

(51) Int. Cl. B64C 13/00

(52) U.S. Cl. 244/99.8

(57) ABSTRACT

A low-profile, actively-controllable flexible piezo-composite actuator with flexibly mated drive, control, and power circuit architecture is presented. The low-profile, functionally-integrated actuator package retains the flexible nature of the actuator while not increasing the overall footprint of the device. The functionally integrated package incorporates flexible structural sensors and embedded control as to enable either active or autonomous control of a unified flexible package that can be installed conformally to non-planar structures. Integral flexible sensors include strain, normal stress, shear stress, pressure, velocity, and acceleration. The invention has immediate applicability to vibration and noise abatement, strain-based compensation, shape control, and structural damping within a variety of aircraft, ships and ground vehicles.

### CROSS REFERENCE TO RELATED APPLICATIONS

This application is based upon and claims priority under 35 U.S.C. §119(e) from U.S. Provisional Application No. 60/649,202 filed Feb. 2, 2005, entitled “Low-Profile, Power-Integrated Actuator for Structural Vibration and Noise Abatement”, the contents of which are hereby incorporated in its entirety by reference thereto.

### FEDERALLY SPONSORED RESEARCH AND DEVELOPMENT

One or more of the inventions disclosed herein were supported, at least in part, by a grant from the National Aeronautics and Space Administration (NASA), Contract No. NNL04AB14P awarded by NASA, Langley Research Center. The Government has certain limited rights to at least one form of the invention(s).

### BACKGROUND OF THE INVENTION

1. Field of the Invention

The present invention generally relates to a low-profile, fully-integrated active control device. Specifically, the invention is a flexible, thin-film actuator wherein the active material layer also functions as the substrate for control circuitry and sensors. The layered arrangement of thin-film actuator, control circuitry, and sensors retains the flexibility of the actuator substrate.

2. Description of the Related Art

Vibration and noise remain a substantial problem to airplanes, helicopters, tilt-rotor craft, automobiles and other vehicles. Aircraft applications are particularly challenging because the source of vibration and noise is disturbances produced by continuous pressure fluctuations.

While vibration and noise remission systems are known, practical applications of these externally controlled and powered technologies are not possible. In general, active damping devices are too large because of the size of the switching power electronics required to drive the actuators within the damping device. Furthermore, active damping requires large linear amplifiers and them management devices which are likewise difficult to accommodate within the volume constraints of most air and ground vehicles. A consequence of large control circuitry is that it precludes its direct integration onto an actuator, since to do so would inhibit the flexibility required of the actuator to properly damp targeted vibrations and noises.

Therefore, what is required is an active damping/control device comprising a flexible, thin-film actuator and drive electronics, wherein the drive electronics is dimensionally compatible with and integral to the form-factor of the actuator mechanism.

What is also required is a fully-integrated, actuator-controller-power-sensor package having a thin, flexible format, so as to be easily applied to a structure wherein access and volume are limited.

### SUMMARY OF INVENTION

An object of the present invention is to provide an active damping/control device comprising a flexible, thin-film actuator and drive electronics, wherein the drive electronics is dimensionally compatible to and integral with the actuator mechanism.

Another object of the present invention is to provide a fully-integrated, actuator-control-power-sensor package having a flexible format which avoids compromising the performance of the active material layer and sensors therein.

The present invention includes an active material substrate that forms an actuator mechanism which is electrically coupled to a contiguous driver circuit, controller circuit, power converter circuit, and including at least one sensor. The multilayer flexible circuitry integrates interconnected power electronics to include miniaturized digital architecture. DC-to-DC converter, inverter, and controller are components with a total footprint contiguous with the active material substrate. These components are mounted onto the active material substrate which may be rigid, semi-rigid or flexible. The modular nature of the present invention enables a fully-integrated active device that is either semi-flexible or flexible so as to easily conform to and allow attachment to planar and non-planar structures.

The flexibility and modular design of the present invention is achieved in a low-profile integrated active device package. In preferred embodiments, the low-profile active substrate includes a flexible or semi-rigid piezoelectric composite.

Drive and control circuitry, namely, Isolation Device Technology or IDT and digital signal processor or DSP circuits, enable a low-noise, power amplifier solution wherein actuator control elements are directly integrated onto a low-profile actuator mechanism. The IDT drive employs a segmented load decoupling output filter within its low-profile packaging. The digital core within the power amplifiers facilitates distributed systems wherein two or more actuators may be controlled by a single master controller. A master/slave control architecture eliminates a wiring harness and ensures scalability.

The flexibility of the thin-film actuator substrate in the layered arrangement of actuator, control circuitry, and sensors is achieved via flex power electronics, flex electrical interconnections, and flex mounted power conversion block. An interdigitated electrode pattern communicates an electric field into the piezoelectric wafer or fibers, comprising the flexible actuator, thus enabling the primary piezoelectric effect within the wafers and fibers. The conformability and flexibility of flexible fiber piezo-composite actuators are typically achieved via an ordered arrangement of piezoelectric wafers or fibers, preferably extruded piezoceramics, within a pliable protective matrix communicating with interdigitated electrodes applied directly onto the matrix, preferably epoxy, or via a polyimide, oppositely disposed about the matrix. Strain energy density is enhanced via interdigitated electrodes which induce in-plane electrical fields along the actuator, thus producing nearly twice the strain actuation and four times the strain energy density of through-plane poled piezoceramic devices.

The electrical traces and components, comprising the control circuitry of the present invention, are deposited and patterned onto the exterior of the actuator via known techniques, including solution-based, direct-write printing and photolithography. For example, solution-based, direct-write printing is a method in which materials are deposited additively only where passive electrical components and interconnections (conductive traces) are required. This method of printing is performed at low-temperatures, thus avoiding temperature and mechanical stability problems inherent with writing circuitry onto a flexible polymer substrate. Furthermore, this method is compatible with continuous roll-to-roll processing and more scalable than lithographic methods.

Several advantages are noteworthy for the present invention. The invention provides complete functionality within a single, yet flexible, package, including integrated power source, drive electronics, sensing, control and actuation that can achieve dynamic flexing requirements. The package can move, bend and even slightly twist without damage to its functional integrity. The invention provides a low-cost, flexible activation mechanism that can be directly coupled to a DC power source. The invention provides structural actuation and sensing that enables directional, conformable actuation in a simple, cost-effective and fully-integrated device. The direct coupling of drive circuitry to interdigitated electrodes in the present invention enhances electrical performance and efficiency. The invention provides an autonomously responsive active mechanism that is conducive to being integrated to conformal (non-flat) surfaces in ships, aircraft and spacecraft. The flex interconnected power/control architecture simplifies connection of the actuator to external instrumentation. The form factor of the present invention is determined solely by the footprint of the active material layer, rather than the footprint of the drive/control circuitry.

### REFERENCE NUMERALS

1 Flexible actuator
2 Active substrate
3 Drive circuit
4 Controller circuit
5 Power converter circuit
6 Power buss supply
7a-7d Flexible sensor
8 Potting material
9a-9e Piezoelectric elements
10 Controller stage
11 Power stage
12 Filter stage
13 Signal conditioner and feedback
14 Modulator
15a-15b Gate drive
16 MOSFETs
17 Filter
18 Output and feedback
19 Feedback loop
20 DC block converter
21 Command signal
22 Output signal
23 Command signal
24 Tunable modulator
25 Gate drive
26 Power stage with IDT circuit
27 Multi-segmented load decoupling filter
28 Output signal
29 Controller
30 Master communication controller
31a-31c Sensor controller
32a-32c Flexible actuator
33 Command and feedback signal
34 Voltage input
35 Output command
36 DC Power command
37 Signal conditioner
38 DSP control laws
39 Signal conditioner
40 Segmented filter
41a, 41b Power stage interface
42a, 42b FET half-bridge with IDT
43a, 43b PWM signal
44 DC buss
45 Structure
46 Thin film
47 Thin film
48a-48e First electrode
49a-49e Second electrode
40a, 50b Flexible interconnect
51 Driver circuit
52 Power signal
53 Matrix

### BRIEF DESCRIPTION OF THE DRAWINGS

The invention will now be described in more detail, by way of example only, with reference to the accompanying drawings, in which:

FIG. 1 is a top view of a schematic representation for one embodiment of the present invention.

FIG. 2 is partial section view of the schematic representation in FIG. 1 showing the flexibility and conformal aspects of the present invention.

FIG. 3 is a perspective view of an exemplary active substrate onto which a drive circuit, controller circuit, power circuit, and sensors are applied.

FIG. 4 is a perspective view of another embodiment of the present invention showing controller, power, and filter stages without flexible substrate interconnected on separate flexible printed circuit boards showing flexibility provided by interconnections between boards.

FIG. 5 is a functional block diagram for the three-stage flex circuit shown in FIG. 4.

FIG. 6 is a block diagram for an exemplary driver circuit.

FIG. 7 is a block diagram for an exemplary system compliant driver.

FIG. 8 is a block diagram for an exemplary network of flexible actuators.

FIG. 9 is a block diagram for an exemplary power converter circuit.

FIG. 10 is a histogram plot showing signal-to-noise ratios for output waveforms at first four harmonic frequencies.

### DETAILED DESCRIPTION OF THE INVENTION

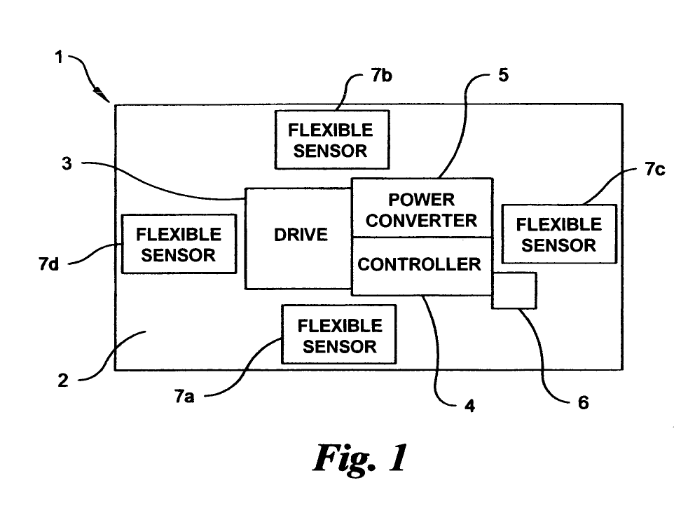

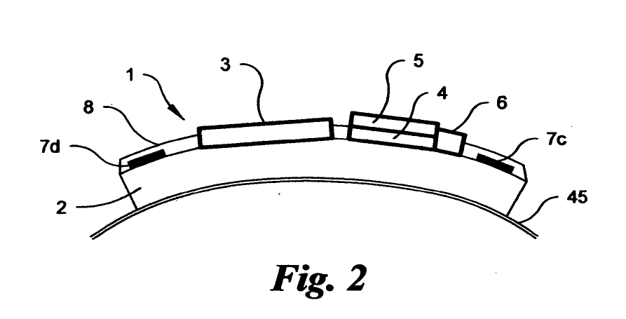

Referring now to FIGS. 1-2, a top-level block diagram of an exemplary flexible actuator 1 is shown and described. The flexible actuator 1 is a fully-functional, patch-like device of arbitrary shape having drive, power, control, and sensing functionality within the lateral extents of the device. The compliant nature of the flexible actuator 1 allows it to conform to the shape of an existing structure 45, so that it is easily mountable thereon and attachable thereto. Components identified in each of the circuits described herein are commercially available devices unless otherwise indicated.

In certain applications, it may be advantageous to partially or completely embed a flexible actuator 1 within a laminate composite or molded polymer of arbitrary shape via laminating and molding methods of manufacture understood within the art. The composite or molded structure should minimize stiffening of the flexible actuator 1 so as to avoid impeding both sensing and shape changing performance characteristics.

The flexible actuator 1 may be mechanically attached, laminated or embedded within a structure 45 or adhesively bonded thereto via a variety of commercially available glues, adhesives or other similar bonding materials. Adhesive material may be pre-applied to the flexible actuator 1 during its manufacture or applied immediately prior to its application onto a structure 45. It is preferred for the adhesive layer to be located along the active substrate 2 opposite of the drive, power, control, and sensing devices, as represented in FIG. 2.

The flexible actuator 1 comprises an active substrate 2 having thereon a drive circuit 3, a power converter circuit 5, an optional controller circuit 4, one or more optional flexible sensors 7a-7d, and a power buss supply 6. Circuits 3-5 and flexible sensors 7a-7d are mounted to the exterior of the active substrate 2, preferably along a common surface, as represented in FIG. 2. A variety of configurations are possible for the arrangement of circuits 3-5 and flexible sensors 7a-7d to optimize sensing fidelity, to minimize communication pathways, and to minimize stiffening of the active substrate 2.

The active substrate 2 is a piezoelectric device capable of changing shape when exposed to an electric field, as described in U.S. Pat. Nos. 5,869,189 and 6,048,622 to Hagood, IV et al., and U.S. Pat. No. 6,629,341 to Wilkie et al.

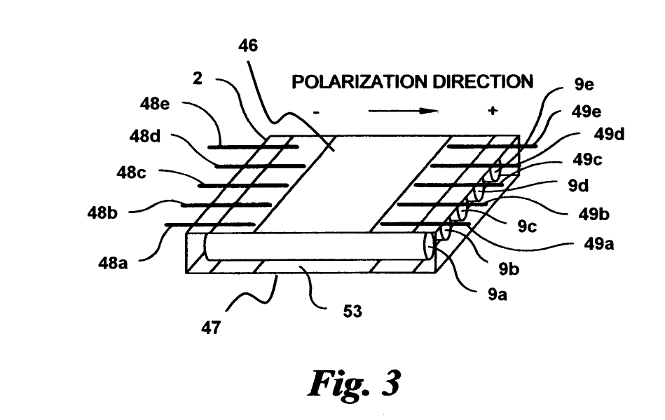

Referring now to FIG. 3, the active substrate 2 in the present invention is shown comprised of a plurality of piezoelectric elements 9a-9e in an ordered arrangement within a matrix 53 of generally planar extent. Piezoelectric elements 9a-9e may include a variety of shapes, designs, and materials; however, it is preferred to have flexible fibers electrically poled lengthwise so as to expand and contract axially and composed of a piezoceramic, one example being PZT, or an electrostrictive material. The matrix 53 is likewise compliant so as to change shape in response to dimensional changes in the piezoelectric elements 9a-9e. The matrix 53 may be composed of a polymer, elastomer, or the like; however, it is preferred for the matrix 53 to be a non-rigid epoxy. Piezoelectric elements 9a-9e are encased within the protective matrix 53 via methods understood in the art.

In some embodiments, it is advantageous to also provide a pair of optional thin films 46, 47 that are either adhesively or otherwise bonded to the matrix 53 in a parallel arranged fashion with respect to the piezoelectric elements 9a-9e. Thin films 46, 47 are likewise compliant so as to change shape in response to dimensional expansion and contraction of the piezoelectric elements 9a-9e. Thin films 46, 47 may be composed of a polyester, one example being Mylar®, a registered trademark of the E.I. DuPont De Nemours and Company located in Wilmington, Del., a polyimide, one example being Kapton®, a registered trademark of the E.I. DuPont De Nemours and Company located in Wilmington, Del., and other flexible polymer material.

A plurality of first electrodes 48a-48e and second electrodes 49a-49e are required to electrically activate the piezoelectric elements 9a-9e. One first electrode 48a-48e and one second electrode 49a-49e are coupled at opposite ends of each piezoelectric element 9a-9e. Electrodes 48a-48e, 49a-49e may be directly integrated into the matrix 53 via flat wires or the like, or printed, etched or deposited, via methods understood in the art, onto each of the thin films 46, 47 so as to provide an interdigitated arrangement.

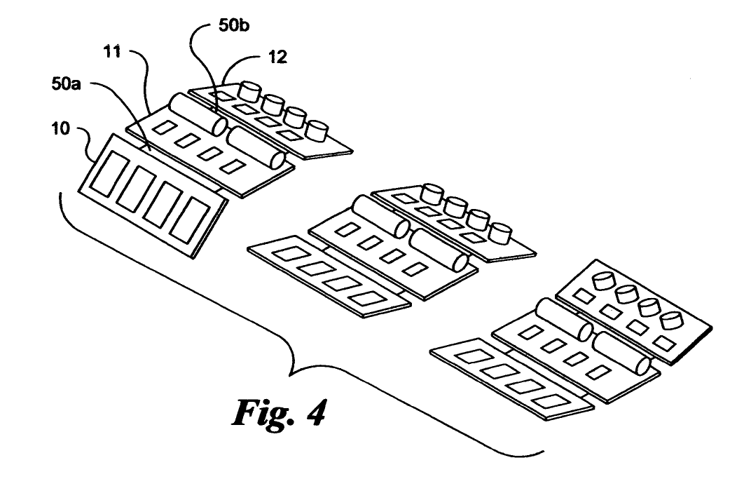

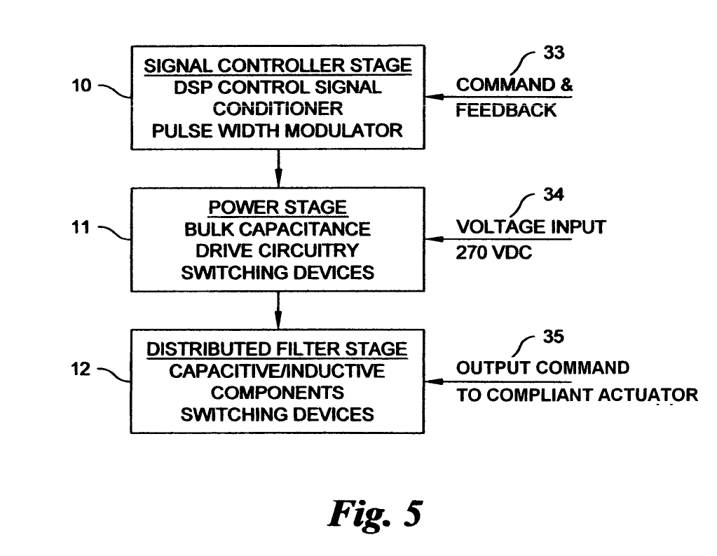

Circuits 3-5 may be fabricated and mounted to the active substrate 2 via a variety of methods. For example in FIG. 4, controller stage 10, power stage 11, and filter stage 12 may be fabricated onto separate flexible circuit boards and electrically coupled with commercially available flexible interconnects 50a, 50b in the order described. Thereafter, the circuit boards are each separately bonded via an adhesive onto the active substrate 2. The controller stage 10 is also electrically coupled so as to receive a command and feedback signal 33 from one or more flexible sensors 7a-7d disposed along the compliant actuator 2. Command and feedback signal 33 facilitates the shape adjustments required along the active substrate 2 to achieve the desired abatement or mitigation function. The power stage 11 is also electrically coupled to a DC power source so as to receive a voltage input 34 which is modified prior to its communication to the active substrate 2 so as to effect the required shape change within the active substrate 2. The filter stage 12 is electrically coupled to the first electrodes 48a-48e and second electrodes 49a-49e so as to communicate an output command 35 in the form of a voltage signal which causes the active substrate 2 to distort.

In yet another method, circuits 3-5 may be deposited or patterned directly onto either the matrix 53 or the thin films 46, 47 disposed about the matrix 53. As such, electrical interconnects or traces within and between circuits 3-5 and passive electrical components comprising the circuit 3-5, namely, resistors, capacitors and the like, are printed, etched or deposited via known techniques, examples including solution-based, direct-write printing and photolithography. Other components comprising the circuits 3-5 are bonded onto the matrix 53 and thin films 46, 47 via techniques understood in the art.

Flexible sensors 7a-7d include a variety of commercial devices capable of measuring strain, stress, shear stress, pressure, velocity, and acceleration. Flexible sensors 7a-7d and electrode patterns (interdigitated and wheatstone bridge) are either bonded to or printed, etched or deposited on, via methods understood in the art or referred to herein, onto the active substrate 2. For example, flexible sensors 7a-7d may be attached to the active substrate 2 via potting materials 8 understood in the art, as represented in FIG. 2.

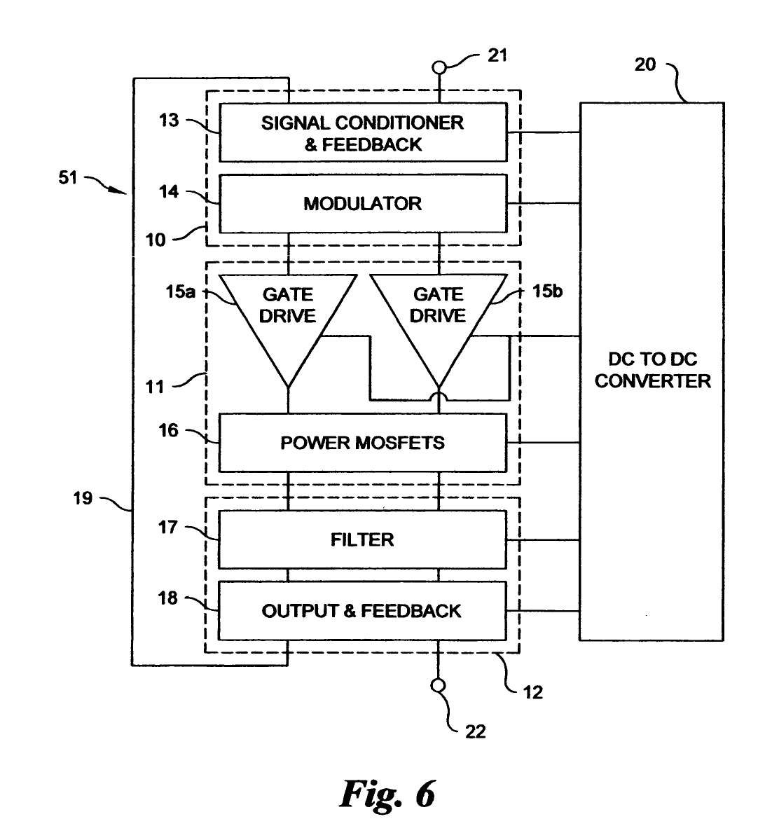

Referring now to FIG. 6, an exemplary driver circuit 51 is shown having the components and electrical connections described therein. The driver circuit 51 includes a DC block converter 20, a controller stage 10, a power stage 11, and a filter stage 12. The controller stage 10 is a digital signal process (DSP) device including a signal conditioner and feedback 13, electrically coupled so as to receive a command signal 21, and a modulator 14. The power stage 11 includes a pair of gate drives 15a, 15b electrically coupled to the modulator 14 and power MOSFETs 16. The filter state 12 includes a filter 17 electrically coupled to the power MOSFETs 16 and an output and feedback 18, also electrically coupled so as to communicate an output signal 22 and a control signal via a feedback loop 19 to the signal conditioner and feedback 13.

In the present invention, the driver circuit 51 is required to drive capacitance loads in the range of 0.01 to 20.0 μF at efficiencies greater than 95% over a broad range of bandwidths from low (sub-hertz to kilohertz and tonal) to high (megahertz). In order to ensure that the driver circuit 51 fits within the planar form factor of most typical active substrates 2, it is generally required to deliver voltages from near-DC to ±100 V_{ac}; however, larger field effect transistor (FET) components may be used to allow for the efficient delivery of ±500 V_{ac}.

Isolation Device Technology (IDT) architecture, described in Non-Provisional patent application Ser. No. 11/201,567 entitled “High Frequency Switch Control” and hereby incorporated in its entirety by reference thereto, ensures the signal-to-noise ratio required to meet the operational performance of the power stage 11. The IDT circuit is a commercial device, one example being circuit model no. IDT-50 sold by QorTek, Inc. located in Williamsport, Pa. The present invention includes a full-bridge output with IDT architecture to significantly improve switching performance by isolating the high and low side devices. As such, inner-bridge coupling of noise and transients are eliminated so as to allow each device to function in a decoupled fashion.

Switching waveforms are likewise tailored to the specific application based upon loads, device type and performance, and noise level. Tailored waveforms ensure the driver circuit 51 functions within a safe operating area (SOA) and exhibits less device dissipation because of the reduced presence of extraneous losses from poor switching practices. The ability to drive devices within their appropriate SOA affords several primary benefits, namely, less output noise, reduced output filtering, higher switching frequencies, and higher overall efficiencies.

Referring now to FIG. 7, a top-level block diagram is shown for an exemplary driver for the active substrate 2. The driver includes a tunable modulator 24, a gate drive 25, a power stage with IDT circuit 26, and a multi-segmented load decoupling filter 27 electrically connected in the order described. A command signal 23 is communicated into the tunable modulator 24 and an output signal 28 is communicated from the multi-segmented load decoupling filter 27.

A converter may be coupled to the IDT circuit described above to facilitate the step-up conversion of a 28 V_{dc} buss to a 150 V_{dc} drive voltage for the active substrate 2. While a three-stage control system is preferred, single and other multi-stage systems are possible. The switching DC power supply converts the 28 V_{dc} to the input voltage required by control system and signal conditioner.

Referring again to FIGS. 1 and 2, the controller circuit 4 obtains measurements from one or more flexible sensors 7a-7d and thereafter communicates command signals to the power converter circuit 5 and drive circuit 3 to control the excitation of one or more active substrates 2. The controller circuit 4 may also control and interrogate flexible sensors 7a-7d and active substrates 2 within an array of such devices. While a variety of commercially available controller circuits 4 are applicable to the present invention, microprocessors with a re-configurable core sold by Silicon Laboratories, Inc., having a corporate address in Austin, Tex., with multi-channel analog-to-digital converters, digital-to-analog converters, comparators, and interface busses (one example being a Controller Area Network), Serial Peripheral Interface (SPI), and 12C (Inter-IC) external interface are preferred. The described controller circuit 4 eliminates external hardware and reduces system weight while providing a simplified means for interfacing flexible sensors 7a-7d, compliant actuator 2, and power converter circuit 5.

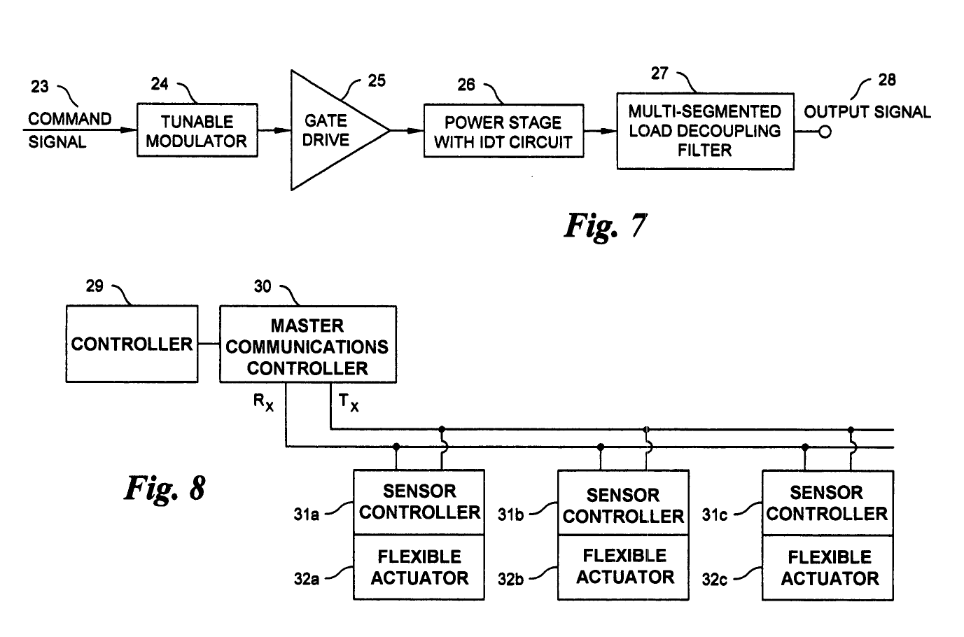

Referring now to FIG. 8, sensor controllers 31a-31c and flexible actuators 32a-32c, or a like number and arrangement of active substrates 2, may be concatenated in a pair-wise arrangement to form one-dimensional and two-dimensional arrays. A master communication controller 30 is electrically connected to two or more sensor controllers 31a-31c and thereby capable of interrogating one or more sensor controllers 31a-31c for data collection purposes and communicating command data to the flexible actuators 32a-32c. The master communication controller 30 is likewise connected to a controller 29 which directs the function of the former.

Each sensor controller 31a-31c has a communications pathway to receive control commands and transmit drive information to and from the master communication controller 30. An exemplary sensor controller 31a-31c is a C2000 model DSP sold by the Texas Instruments Company. Preferred devices included a 16-bit, 40 MHz DSP with embedded PWM, analog-to-digital converters, serial communications interface, internal RAM, and internal program FLASH ROM. A small DSP allowed more sensor controllers 31a-31c for greater sensing fidelity.

The primary responsibility of each sensor controller 31a-31c is to digitally stabilize the power driver based upon commands it receives from the master communication controller 30 and feedback from an output driver card. Commands are transmitted from the digital-to-analog converter within the master communication controller 30. Voltage and current feedback signals are routed back to an analog-to-digital convert within each DSP.

In some embodiments, it may be preferred to have a DSP with a faster clock speed and capable of generating a pulse width modulated (PWM) signal upwards of 150 kHz so as to reduce the power supply output filter requirements. It is likewise preferred for the DSP to be signal processing capable and, if applicable, to allow multiple flexible actuators 32a-32c to be controlled by one DSP. For example, the DSP sub-system in FIG. 8 employed a C2810 DSP sold by the Texas Instrument Company. The C2810 DSP enables sixteen analog input channels to provide additional feedback points for evaluation purposes. The C2810 DSP has the communication performance of a LF2401 DSP, yet with a Serial Peripheral Interface (SPI), thus enabling data communication back to the master communication controller 30.

Preferred embodiments of the present invention include selectable feedback allowing a function generator or accelerometer as the feedback source. Signal conditioning may be required prior to analog-to-digital conversion so that high-frequency or out-of-band noise is removed. Filtering prevents aliasing and extraneous noise from occurring. After the command signal is digitized, it is used as the command for the proportional-integral (PI) control algorithm. The PI control algorithm either recreates the command at the power supply output, when the feedback source is a function generator, or nulls any motion, when the feedback source is an accelerometer. Two additional feedback channels for voltage and current may be used for feedback from the power supply so as to allow the command signal from a function generator to be accurately recreated at the flexible actuators 32a-32c. Protection also is incorporated into the control so that power supply and flexible actuators 32a-32c are not overdriven.

Identified DSPs maximize flexibility, robustness, and re-configurability in the control algorithm. A further advantage of the identified DSPs is quick and easy software modifications and improvements to adjust algorithm parameters or to alter the control approach. Although analog PWM controllers may provide acceptable performance, their adaptability and re-configurability are limited thereby preventing additional functionality after a design is implemented. Another limitation of analog controllers is that non-linear functions, such as adaptive least-mean-square (LMS) filters, are difficult to achieve with analog components and often approximated thereby. Software implementations of non-linear features are simpler and more precise with software in digital DSPs. While preferred embodiments of the present invention include a control algorithm current that is primarily linear, non-linear control functions are preferred for scalability and upgradeability purposes.

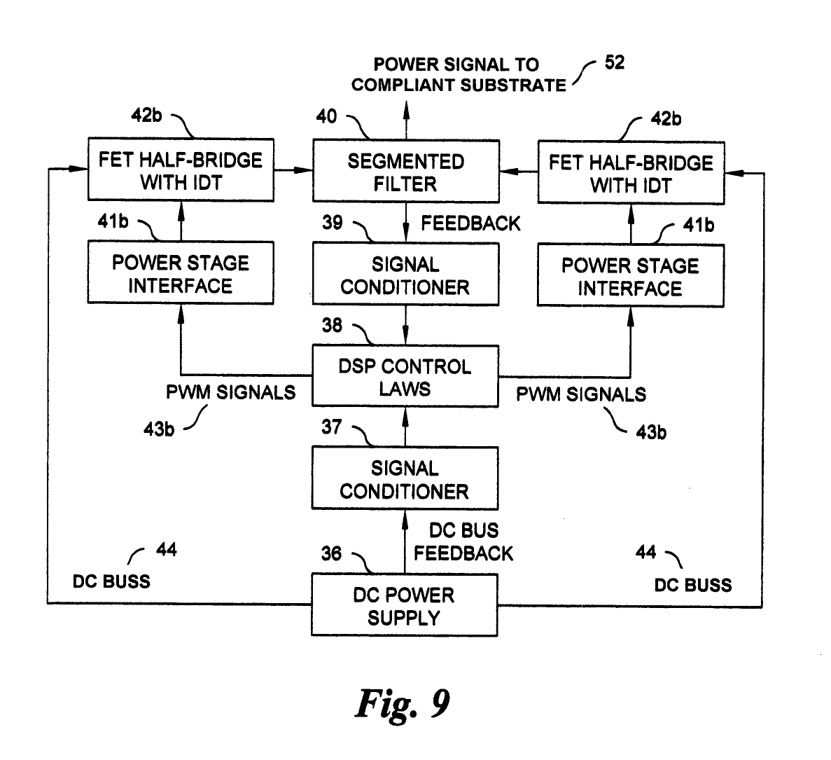

Referring now to FIG. 9, an exemplary topology for a Texas Instrument DSP for control of the power stage 11 is shown. A DC power supply 36 is electrically connected to a pair of FET half-bridges with IDT 42a, 42b via a DC buss 44. DSP control laws 38 are algorithms embedded within DSP firmware. DSP algorithms independently control the two half-bridges to implement a POLYBRIDGE®, a registered trademark of QorTek, Inc., circuit. The DSP control laws 38 generate independent PWM signals 43a, 43b electrically communicated to a pair of FET half-bridges with IDT 42a, 42b through a level-shifting power stage interface 41a, 41b. The output from each FET half-bridge with IDT 42a, 42b is communicated to a multi-pole, segmented filter 40 which combines the half-bridge outputs. The resulting output is a power signal 52 used to drive one or more active substrates 2 directly or one or more flexible actuators 1. Voltage and current feedback signals from each of the FET half-bridges with IDT 42a, 42b are communicated to a signal conditioner 39 and thereafter to the DSP control laws 38. Likewise, voltage and current feedback signals from the DC power supply 36 are communicated to a signal conditioner 37 and thereafter to the DSP control laws 38.

Feedback signals to the DSP control laws 38 are analyzed to stabilize drive signals to loads, as well as, to maintain circuit protection and health monitoring. The DSP control laws 38 employ multi-staged proportional integral control loops for each half bridge to recreate input command signals. Loops are coupled with non-linear functions, such as signal limiting and command shut-down, for system protection. Algorithms are coded and assembled to maximize efficiency and execution speed and enable multi-channel capability. The described methodology allows for an adaptive LMS noise cancellation algorithm within the DSP driver for the power stage 11. As such, functionality is directly implemented into the controller without requiring a bulky external PC or embedded computer.

In some embodiments, a converter having an operational frequency above 100 kHz may be required to eliminate noise generated by the step-down DC-to-DC converter. In yet other embodiments, it may be required to damp interactions between the active substrate 2 and output filter to eliminate extraneous noise and bring the single-to-noise ratio into an acceptable range. It is likewise possible to reduce DC-to-DC converter noise by having the drive operate at a nominal 28 V_{dc}. As such, the duty cycle is in a range typically associated with efficient power conversion. The power stage DC buss voltage is also stepped up, which is generally an easier, low-noise task.

In some embodiments, a voltage of 150 V_{dc} is used to directly supply the power stage 11 with some filtering and control system voltages are stepped down. In yet other embodiments, it may be required to step up the power stage buss voltage. The step-up conversion of the 150 V_{dc} buss may be performed via a commercially available converter, one example being Converter Model No. SRC-50, sold by QorTek, Inc.

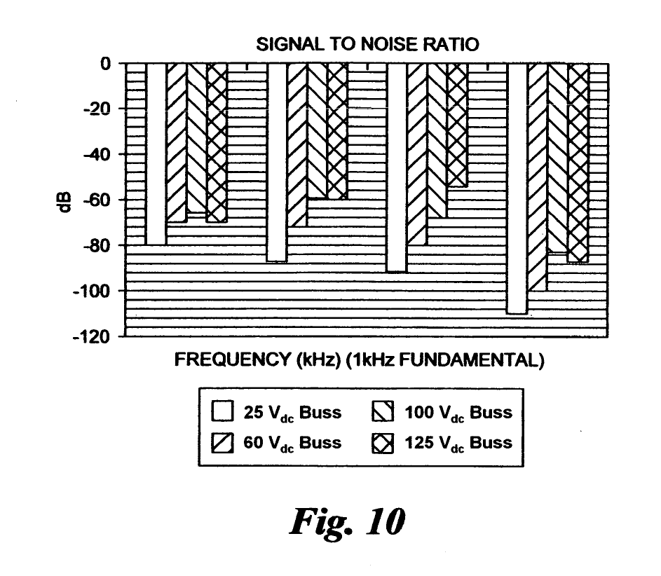

Exemplary signal-to-noise ratios (SNR) are shown in FIG. 10 for output voltage waveforms at four buss voltages, namely, 25 V_{dc}, 60 V_{dc}, 100 V_{dc}, and 125 V_{dc} for one embodiment of the present invention. SNRs are shown in decibels (dB) for the first four incremental harmonic frequencies of the fundamental 1-kHz drive waveform. SNR data demonstrates the described circuitry is capable of achieving an SNR of 60 dB and that 70 to 80 dB is attainable.

The description above indicates that a great degree of flexibility is offered in terms of the present invention. Although the present invention has been described in considerable detail with reference to certain preferred versions thereof, other versions are possible. Therefore, the spirit and scope of the appended claims should not be limited to the description of the preferred versions contained herein.

1. An actively controllable flexible actuator comprising:
(a) an active substrate comprising:
(i) a compliant matrix;
(ii) a plurality of electrically poled active elements disposed in an ordered arrangement within said compliant matrix, said electrically poled active elements comprised of a piezoelectric material or an electrostrictive material; and
(iii) a plurality of electrodes whereby one said electrode is electrically coupled at each end of each said electrically poled active element;
(b) a drive circuit disposed on said active substrate and electrically coupled to said electrically poled active elements;
(c) a power converter circuit disposed on said active substrate and electrically coupled to said drive circuit; and
(d) a flexible electrical circuit interconnecting said active electrically poled active elements, said drive circuit, and said power converter.

2. The actively controllable flexible actuator of claim 1, wherein said drive circuit and said power converter circuit are printed, deposited or etched onto said active substrate.

3. The actively controllable flexible actuator of claim 1, wherein said drive circuit and said power converter circuit are printed, deposited or etched onto a flexible circuit substrate which is flexibly mounted on said active substrate.

4. The actively controllable flexible actuator as in claim 1, 2 or 3, wherein said drive circuit and said power converter circuit are mounted separately onto at least two circuit boards each separately attached to said active substrate.

5. The actively controllable flexible actuator of claim 1, wherein said actively controllable flexible actuator is embedded within a laminated composite or a molded polymer.

6. The actively controllable flexible actuator of claim 1, further comprising:
(e) at least one flexible sensor mounted on said active substrate and capable of measuring the dynamic behavior of a structure contacted by said actively controllable flexible actuator; and
(f) a controller circuit mounted on said active substrate and electrically coupled between said flexible sensor and said power converter circuit, said controller circuit receiving data from said flexible sensor and adjusting power to said flexible actuator.

7. The actively controllable flexible actuator of claim 6, wherein portions of said drive circuit, said power converter circuit, said controller circuit and said electrical interconnections are printed, deposited or etched onto said active substrate.

8. The actively controllable flexible actuator of claim 6, wherein portions of said flexible sensor are printed, deposited or etched directly onto said active substrate.

9. The actively controllable flexible actuator of claim 8, wherein said flexible sensor includes at least one shear, strain, or load sensor enabled by direct printing or photolithography of patterned electrodes including interdigitated and wheatstone bridge.

10. The actively controllable flexible actuator of claim 6, wherein said drive circuit, said power converter circuit, and said controller circuit are mounted separately onto at least three boards and attached to said active substrate via said flexible electrical circuit.

11. The actively controllable flexible actuator of claim 6, wherein said actively controllable flexible actuator is embedded within a laminated composite or a molded polymer.

12. The actively controllable flexible actuator of claim 6, wherein said active substrate further comprising:
(iv) a pair of compliant thin films oppositely disposed about and mounted to said compliant matrix, said electrodes disposed on said compliant thin films.

13. The actively controllable flexible actuator of claim 12, wherein said drive circuit, said power converter circuit, and said controller circuit are printed, deposited or etched onto said active substrate.

14. The actively controllable flexible actuator of claim 12, wherein said drive circuit, said power converter circuit, and said controller circuit are mounted separately onto at least three circuit boards mounted to said active substrate.

15. The actively controllable flexible actuator of claim 12, wherein at least one said compliant flexible sensor is printed, deposited or etched onto said active substrate.

16. The actively controllable flexible actuator of claim 12, wherein said electrodes are interdigitated.

17. The actively controllable flexible actuator of claim 12, wherein said actively controllable flexible actuator is embedded within a laminated composite or a molded polymer.

18. The actively controllable flexible actuator of claim 1, wherein said active substrate further comprising:
(iv) a pair of compliant thin films oppositely disposed about and mounted to said compliant matrix, said electrodes disposed on said compliant thin films.

19. The actively controllable flexible actuator of claim 18, wherein said drive circuit and said power converter circuit are printed, deposited or etched onto said active substrate.

20. The actively controllable flexible actuator of claim 18, wherein said electrodes are interdigitated.

21. The actively controllable flexible actuator of claim 18, wherein said drive circuit and power converter circuit are mounted separately onto at least two circuit boards attached to said active substrate.

22. The actively controllable flexible actuator of claim 18, wherein said actively controllable flexible actuator is embedded within a laminated composite or a molded polymer.
